(19) United States
(12) Patent Application Publication
(10) Pub. No.: US 2008/0251388 A1
(43) Pub. Date: Oct. 16, 2008

(54) METHOD OF PREPARING HIGHLY THERMALLY CONDUCTIVE CIRCUIT SUBSTRATE

(75) Inventors: Hsu-Tan HUANG, Taipei County (TW); Chung-Lin Chou, Taipei County (TW)

Correspondence Address: BROWDY AND NEIMARK, P.L.L.C.;624 NINTH STREET, NW, SUITE 300, WASHINGTON, DC, 20001-5303, US

(73) Assignee: Cosmos Vacuum Technology Corp., Taipei County (TW)

(21) Appl. No.: 11/775,482

(22) Filed: Jul. 10, 2007

(30) Foreign Application Priority Data
Apr. 10, 2007 (TW) 96112543

(51) Int. Cl. C25D 5/00; B05D 5/12; C25D 11/02

(52) U.S. Cl. 205/171; 427/96.8

(57) ABSTRACT

A method of preparing a highly thermally conductive circuit substrate includes the steps of preparing a metallic substrate, producing an insulated layer on a surface of the metallic substrate, producing an intermediate medium layer on a surface of the insulated layer, and producing an electrically conductive main layer on a surface of the intermediate medium layer.

### BACKGROUND OF THE INVENTION

1. Field of the Invention

The present invention relates generally to surface treatment technology, and more particularly, to a method of preparing a highly thermally conductive circuit substrate.

2. Description of the Related Art

Referring to FIG. 1, Taiwan Patent Pre-grant No. 200520670 disclosed an integrated thermally conductive substrate and a method of preparing the same. The method includes the steps of preparing a metallic substrate 1, producing an insulated layer 2 made of aluminum trioxide on the metallic substrate 1 by means of micro arc oxidation (MAO) anodizing for thermal conduction, and disposing a metallic film 3, which is made of copper and has a predetermined design, on the insulated layer with a vacuum-coated film to define a plurality of metal wires and to produce an integrated thermally conductive substrate 4. This invention is for the purpose of integration, thermal conduction, and circuit layout in such a way that the metallic substrate 1 is provided for thermal conductivity, the insulated layer 2 is provided for electrical insulation, and the metal film 3 is provided for circuit layout.

However, the insulated layer 2 is much different from the metal film 3 in physical property, like coefficient of expansion, and both of the insulated layer 2 and the metallic film 3 are applicable to the processing of high temperature first and then low temperature, so that the integrated thermally conductive substrate is subject to having raised surface resulted from stress. Especially for the large substrate, the raised surface is more obvious. The substrate is also subject to peeling, i.e. the peel strength is low.

In addition, the electrical conductivity of circuit will be preferable if the thickness of the electrically conductive layer is at least 13 μm, the electrical conductivity of circuit having higher power will be preferable if the electrically conductive layer is at least 20 μm. However, the thickness of the above-mentioned metallic film 3 made by the vacuum coating is 9 μm at most and if it is more than 9 μm, the metal film 3 may peel off, such that the above-mentioned thermally conductive substrate is defective in that the metallic film 3 is too thin to have preferable electrical conductivity. Furthermore, the vacuum coating by which the electrically conductive film is made is slower in formation of the film to defectively take more working hours. In other words, the vacuum coating that the electrically conductive film is made has drawbacks of imperfect electric conductivity and costing more working hours.

Because the insulated layer 2 made of aluminum trioxide of the above-mentioned substrate is made by MAO anodizing and the crystal structure of aluminum trioxide is superimposed other than regularly columnar, the thermal conductivity of the substrate is imperfect for further improvement.

In light of the above, the conventional thermally conductive substrate is defective to cost more working hours and to have lower production efficiency as well as imperfect thermal conductivity.

### SUMMARY OF THE INVENTION

The primary objective of the present invention is to provide a method of preparing a highly thermally conductive circuit substrate, which accelerates the manufacturing process.

The secondary objective of the present invention is to provide a method of preparing a highly thermally conductive circuit substrate, which enhances the adhesion of the electrically conductive layer and thickens the same to enable preferable electrical conductivity.

The third objective of the present invention is to provide a method of preparing a highly thermally conductive circuit substrate, which has preferable electrical conductivity.

The foregoing objectives of the present invention are attained by the method including the steps of preparing a metallic substrate, producing an insulated layer on a surface of the metallic substrate, producing an intermediate medium layer on a surface of the insulated layer, and producing an electrically conductive main layer on a surface of the intermediate medium layer by electrochemical technology. In light of these steps, the intermediate medium layer balances the physical property of the insulated layer and the electrically conductive main layer to enhance the adhesion of the electrically conductive main layer, such that the circuit substrate can have preferable structural strength. Furthermore, the present invention employs the electrochemical technology for post manufacturing process of the electrically conductive main layer to further accelerate the process. In addition, the present invention provides another step of producing the insulated layer to further increase the regularity of the crystal morphology of the insulated layer, thus having preferable thermal conductivity.

### BRIEF DESCRIPTION OF THE DRAWINGS

FIG. 1 is a sectional view of the conventional integrated thermally conductive substrate.

FIG. 2 is a block diagram of a first preferred embodiment of the present invention.

FIG. 3 is a sectional view of the first preferred embodiment of the present invention, illustrating the metallic substrate before the anodizing.

FIG. 4 is a sectional view of the first preferred embodiment of the present invention, illustrating the metallic substrate after the anodizing.

FIG. 5 is a sectional view of the first preferred embodiment of the present invention, illustrating the metallic substrate after the first medium layer is formed.

FIG. 6 is a sectional view of the first preferred embodiment of the present invention, illustrating the metallic substrate after the electrically conductive medium layer is formed.

FIG. 7 is a sectional view of the first preferred embodiment of the present invention, illustrating the metallic substrate after the electrically conductive main layer is formed by means of the electrochemical technology.

FIG. 8 is a sectional view of a second preferred embodiment of the present invention, illustrating the structure of the electrically conductive medium layer and the electrically conductive main layer.

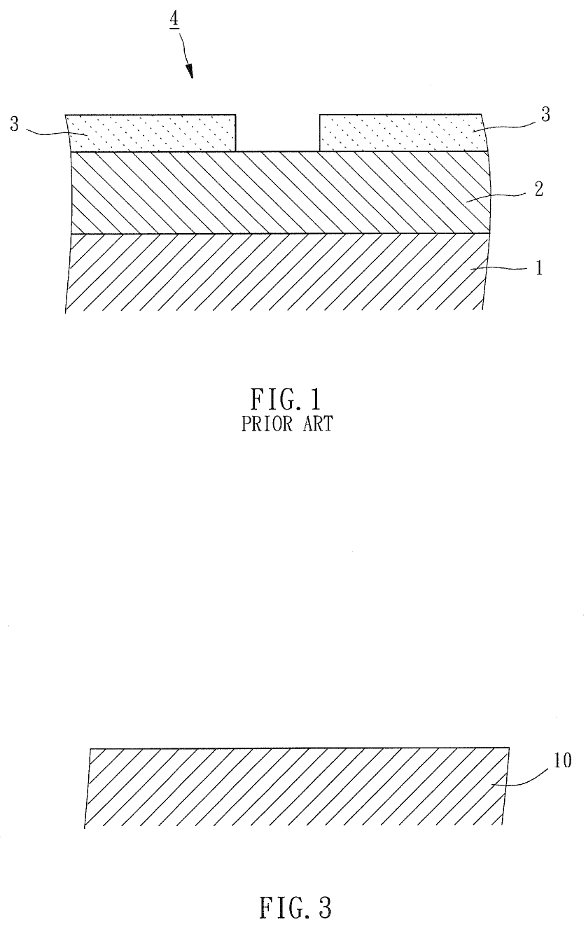

### DETAILED DESCRIPTION OF PREFERRED EMBODIMENTS

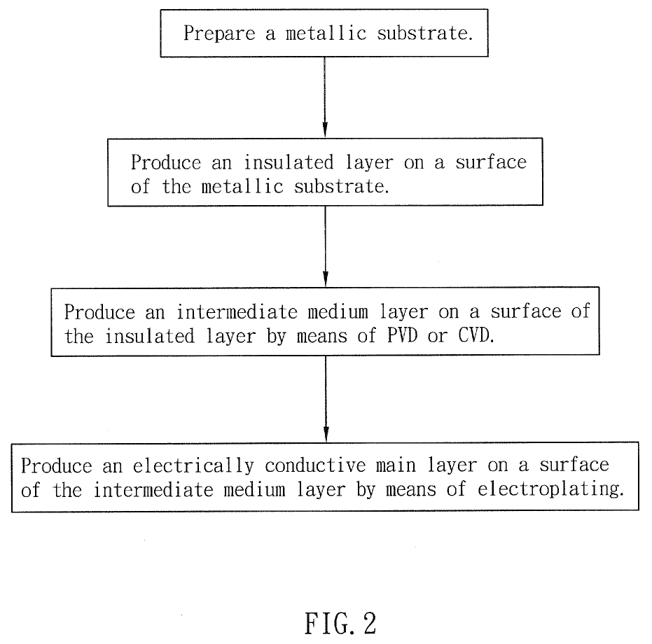

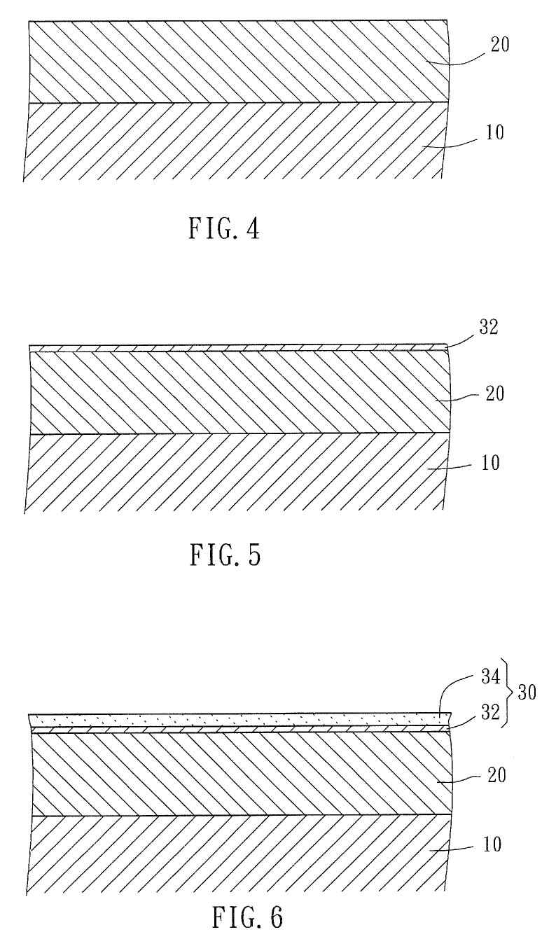

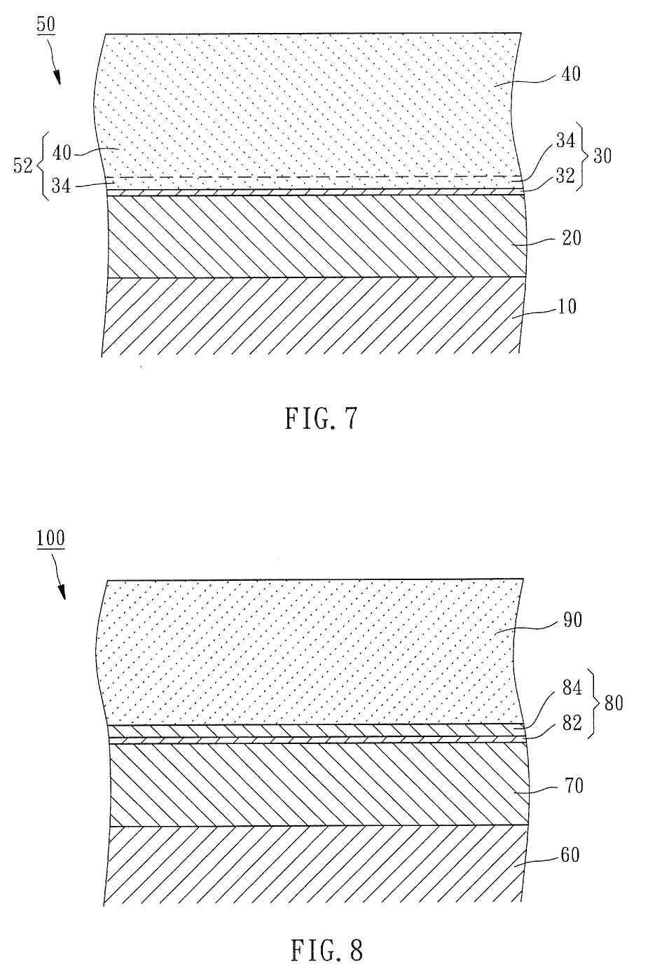

Referring to FIGS. 2-7, a method of preparing a highly thermally conductive circuit substrate according to a first preferred embodiment of the present invention includes the following steps.

A. Prepare a metallic substrate 10. The metallic substrate 10 is made of a material selected from a group consisting of aluminum, magnesium, titanium, and an alloy of them. In this embodiment, the metallic substrate 10 is made of aluminum.

B. Produce an insulated layer 20 on a surface of the metallic substrate 10. The insulated layer 20 is made of a compound of at least one of aforementioned metals. In this embodiment, the insulated layer 20 is made of an oxide of at least one of the aforementioned metals. The insulated layer 20 is aluminum trioxide formed on the surface of the metallic substrate 10 by means of general anodizing, such as MAO anodizing and plasma electrolytic oxidation (PEO). However, to enable preferable thermal conductivity of the insulated layer 20 of aluminum trioxide, the aluminum trioxide is formed by means of electrochemical colloid oxidation (ECCO) anodizing developed by the present inventor. The ECCO anodizing is characterized in that the working solution is oxalic acid, the predetermined working voltage is 260-400 volts, and the predetermined working current is 1-6 A/dm², enabling preferable regularity of the crystal morphology of the insulated layer 20 and preferable thermal conductivity.

C. Produce an intermediate medium layer 30 on a surface of the insulated layer 20 by means of physical vapor deposition (PVD) or chemical vapor deposition (CVD). The intermediate medium layer 30 is formed of a first medium layer 32 and an electrically conductive medium layer 34 one by one. The first medium layer 32 is located between the insulated layer 20 and the electrically conductive medium layer 34. The first medium layer 32 is made of magnesium, aluminum, titanium, vanadium, chromium, nickel, zirconium, molybdenum, tungsten, or a compound of at least one of them. In this embodiment, the first medium layer 32 is titanium dioxide. The electrically conductive medium layer 34 is made of aluminum, cobalt, nickel, copper, zinc, argentums, tin, platinum, or gold. In this embodiment, the electrically conductive medium layer 34 is made of copper and is provided with thickness smaller than 1 μm, such that it takes shorter time for formation of a film.

D. Produce an electrically conductive main layer 40 on a surface of the intermediate medium layer 30 by means of the electrochemical technology, i.e. electroplating in this embodiment. The electrically conductive main layer 40 is located on a surface of the electrically conductive medium layer 34 of the intermediate medium layer 30. The electrically conductive main layer 40 is made of aluminum, cobalt, nickel, copper, zinc, argentums, tin, platinum, or gold. In this embodiment, the electrically conductive main layer 40 is made of copper and is provided with thickness of 35 μm larger than 13 μm. The electrically conductive main layer 40 and the electrically conductive medium layer 34 can be incorporated to form an electrically conductive layer 52. A predetermined design can be formed on the electrically conductive layer 52 by means of milling or mask erosion.

After the above steps, a highly thermally conductive circuit substrate 50 is prepared. The technical features of the present invention are recited as follows. The first medium layer 32 and the electrically medium layer 34 are formed one by one on the insulated layer 20. The first medium layer 32 is acted as a buffer interface between the insulated layer 20 and the electrically conductive medium layer 34 for balance of the physical property of the insulated layer 20 and the medium layer 34 and further for enhancement of the adhesion of the electrically conductive medium layer 34, thus enabling the highly thermally conductive circuit substrate 50 to have preferable peel strength. The electrically conductive medium layer 34 is formed as a metallic electrode in advance to be a required electrode for a workpiece in the next step of the electroplating and for formation of the electrically conductive main layer 40 on the electrically conductive medium layer 34.

Because the processing rate of PVD or CVD is slow, the present invention produces an ultra-thin electrically conductive layer 34, which thickness is smaller than 1 μm, to shorten the processing time, and produces the electrically conductive main layer 40 on the surface of the electrically conductive medium layer 34 by means of the electroplating quicker than PVD or CVD to accelerate the formation of the electrically conductive main layer 40, thus increasing the rate of the manufacturing process. Meanwhile, the thickness of the electrically conductive main layer 40 can reach 35 μm larger than 13 ∥m to enhance the electric conductivity of the highly thermally conductive circuit substrate 50.

After the test of the highly thermally conductive circuit substrate 50, the thermal conductivity can reach 100 W/m·K high and more and thus the thermal conductivity is definitely enhanced.

Referring to FIG. 8, a method of preparing a highly thermally conductive circuit substrate according to a second preferred embodiment of the present invention includes the following steps.

A. Prepare a metallic substrate 60. The metallic substrate 60 is made of a material selected from a group consisting of aluminum, magnesium, titanium, and an alloy of at least one of them. In this embodiment, the metallic substrate 60 is made of aluminum.

B. Produce an insulated layer 70 on a surface of the metallic substrate 60. The insulated layer 70 is aluminum trioxide formed on the surface of the metallic substrate 60 by means of the conventional MAO anodizing and the PEO anodizing. However, to enable preferable thermal conductivity of the insulated layer 70, the aluminum trioxide is formed by means of the ECCO anodizing developed by the present inventor.

C. Produce an intermediate medium layer 80 on a surface of the insulated layer 70 by means of the PVD. The intermediate medium layer 80 is formed of a first medium layer 82 and an electrically conductive medium layer 84 one by one. The first medium layer 82 is located between the insulated layer 70 and the electrically conductive medium layer 84. The first medium layer 82 is made of magnesium, aluminum, titanium, vanadium, chromium, nickel, zirconium, molybdenum, tungsten, or a compound of at least one of them. In this embodiment, the first medium layer 82 is titanium dioxide. The electrically conductive medium layer 84 is made of aluminum, cobalt, nickel, copper, zinc, argentums, tin, platinum, or gold. In this embodiment, the electrically conductive medium layer 84 is made of argentums and is provided with thickness smaller than 1 μm.

D. Produce an electrically conductive main layer 90 on a surface of the intermediate medium layer 80 by means of the electroplating. The electrically conductive main layer 80 is located on a surface of the electrically conductive medium layer 84 of the intermediate medium layer 80. The electrically conductive main layer 90 is made of aluminum, cobalt, nickel, copper, zinc, argentums, tin, platinum, or gold. In this embodiment, the electrically conductive main layer 90 is made of copper and is provided with thickness of 35 μm larger than 13 μm.

After the above steps, a highly thermally conductive substrate 100 is prepared and is similar to the highly thermally conductive substrate 50 of the first embodiment but different in that the electrically conductive medium layer 84 and the electrically conductive main layer 90 are made of different metals respectively to attain the same effect as the first embodiment.

It is to be noted that in the step B, the metallic substrate 10 can alternatively be treated on the surface thereof by nitrogenization to form aluminum nitride or by the oxidization and the nitrogenization at the same time to form a nitroxide of aluminum to enable preferable high thermal conductivity. In addition, if a specific circuit layout is intended to be formed on the substrate, both of the medium layer of the step C and the electrically conductive layer of the step D can be treated by means of the mask erosion to form a predetermined design thereon; or alternatively, the electrically conductive layer of the step D can be treated by means of the milling or mask erosion to form a predetermined design.

In conclusion, in light of the steps set forth in two preferred embodiments of the present invention, the medium layer balances the physical property of the insulated layer and the electrically conductive main layer to enhance the adhesion of the electrically conductive main layer to further enable preferable structural strength for the highly thermally conductive circuit substrate. In addition, the present invention employs the electrochemical technology for the post manufacturing process of the electrically conductive main layer to enhance the rate of the manufacturing process. Moreover, the present invention further thickens the electrically conductive layer to have better electrical conductivity. At last, the thermally conductive substrate of the present invention has better thermal conductivity on a whole.

Although the present invention has been described with respect to specific preferred embodiments thereof, it is no way limited to the details of the illustrated structures but changes and modifications may be made within the scope of the appended claims.

1. A method of preparing a highly thermally conductive circuit substrate comprising steps of:
(a) preparing a metallic substrate;
(b) producing an insulated layer on a surface of said metallic substrate;
(c) producing an intermediate medium layer on a surface of said insulated layer; and
(d) producing an electrically conductive main layer on a surface of said medium layer.

2. The substrate as defined in claim 1, wherein said metallic substrate is made of a material selected from a group consisting of aluminum, magnesium, titanium, and an alloy of at least one of the aforesaid metals.

3. The substrate as defined in claim 1, wherein said insulated layer in the step (b) is formed by means of electric-chemical colloid oxidization (ECCO) anodizing which working solution is oxalic acid, which predetermined working voltage is 260-400 volts, and which predetermined working current is 1-6 A/dm₂.

4. The substrate as defined in claim 1, wherein said insulated layer in the step (b) is a compound formed on the surface of said metallic substrate.

5. The substrate as defined in claim 1, wherein said intermediate medium layer in the step (c) comprises a first medium layer and an electrically conductive medium layer one by one, said first medium layer being located between said insulated layer and said electrically conductive medium layer.

6. The substrate as defined in claim 5, wherein said first medium layer in the step (c) is made of magnesium, aluminum, titanium, vanadium, chromium, nickel, zirconium, molybdenum, tungsten, or a compound of at least one of aforesaid elements.

7. The substrate as defined in claim 6, wherein said first medium layer in the step (c) is titanium dioxide.

8. The substrate as defined in claim 5, wherein said electrically conductive medium layer is made of aluminum, cobalt, nickel, copper, zinc, argentums, tin, platinum, or gold.

9. The substrate as defined in claim 5, wherein said electrically conductive main layer in the step (d) is formed on a surface of said electrically conductive medium layer of said intermediate medium layer.

10. The substrate as defined in claim 5, wherein said electrically conductive medium layer in the step (d) has thickness smaller than 1 μm.

11. The substrate as defined in claim 1, wherein said electrically conductive main layer in the step (d) is made of aluminum, cobalt, nickel, copper, zinc, argentums, tin, platinum, or gold.

12. The substrate as defined in claim 1, wherein said electrically conductive main layer in the step (d) has thickness of at least 13 μm.

13. The substrate as defined in claim 1, wherein said insulated layer in the step (b) is formed by means of nitrogenization to be nitride of said metallic substrate.

14. The substrate as defined in claim 1, wherein said insulated layer in the step (b) is formed by means of nitrogenization and oxidization to be nitroxide of said metallic substrate.

15. The substrate as defined in claim 1, wherein each of said intermediate medium layer in the step (c) and the electrically conductive layer in the step (d) is formed with a predetermined design.

16. The substrate as defined in claim 1, wherein said electrically conductive layer in the step (d) is formed with a predetermined design by means of milling or mask erosion.

17. (canceled)

18. The substrate as defined in claim 1, wherein said electrically conductive main layer is produced by electrochemical technology.

19. The substrate as defined in claim 18, wherein said electrochemical technology in the step (d) is electroplating.
